(19) United States
(12) Patent Application Publication
(10) Pub. No.: US 2025/0219498 A1
(43) Pub. Date: Jul. 3, 2025

(54) MOTOR ASSEMBLY, PUMP, AND BOILER INCLUDING THE SAME

(71) Applicant: KYUNGDONG NAVIEN CO., LTD., Pyeongtaek-si (KR)

(72) Inventors: Jun Kyu Park, Seoul (KR); Tae Seong Kwon, Seoul (KR); Young Jae Noh, Seoul (KR); Jeong Woo Kim, Seoul (KR); Gung Geun Nam, Seoul (KR)

(21) Appl. No.: 19/003,252

(22) Filed: Dec. 27, 2024

(30) Foreign Application Priority Data
Dec. 29, 2023 (KR) 10-2023-0197398

(51) Int. Cl. H02K 5/24; F04D 13/06; H02K 5/16; H02K 7/08

(52) U.S. Cl. CPC H02K 5/24; F04D 13/0633; H02K 5/161; H02K 7/083

(57) ABSTRACT

Disclosed is a motor assembly including a rotary shaft, a fixing unit that supports the rotary shaft such that the rotary shaft is rotatable, and a motor housing accommodating at least a portion of the fixing unit, and directly contacting the fixing unit to support the fixing unit.

### CROSS-REFERENCE TO RELATED APPLICATION

This application claims the benefit of priority to Korean Patent Application No. 10-2023-0197398, filed in the Korean Intellectual Property Office on Dec. 29, 2023, the entire contents of which are incorporated herein by reference.

### TECHNICAL FIELD

The present disclosure relates to a motor assembly, a pump, and a boiler including the same.

### BACKGROUND

A pump may be provided to circulate a fluid, such as water. In particular, a heating device, such as a boiler, may include a pump to heat water, and the like through a burner and then send the heated water to a desired site. The pump may transmit power to the water by rotating an impeller to circulate the water. To rotate the impeller, the impeller may be coupled to a rotary shaft of a motor assembly on one side.

However, when the rotary shaft is rotated and a rotation axis is inclined, vibration may occur, and noise may be generated.

### SUMMARY

The present disclosure has been made to solve the above-mentioned problems occurring in the prior art while advantages achieved by the prior art are maintained intact.

An aspect of the present disclosure provides a motor assembly, a pump, and a boiler including the same, by which a rotation axis of a rotary shaft is prevented from being inclined.

An aspect of the present disclosure also provides a motor assembly, a pump, and a boiler including the same, by which generation of vibration and noise are suppressed.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a motor assembly includes a rotary shaft, a fixing unit that supports the rotary shaft such that the rotary shaft is rotatable, and a motor housing accommodating at least a portion of the fixing unit, and directly contacting the fixing unit to support the fixing unit.

The fixing unit may include a bearing coupled to be adjacent to one end of the rotary shaft, a stator can, in which at least a portion of the rotary shaft is accommodated, and a bushing holder, in which the bearing is accommodated, and at least a portion of which is accommodated in the stator can, and the motor housing may contact the stator can.

The bushing holder may include a bushing holder body, to which the bearing is coupled, and a holder neck extending along an extension direction of the rotary shaft from the bushing holder body to an outside of the stator can, and the motor housing may include a support flange contacting the holder neck.

The fixing unit may further include a plug bolt coupled to the holder neck along the extension direction of the rotary shaft, and the support flange may be located between the bushing holder body and the plug bolt.

The fixing unit may further include a bolt packing located between the plug bolt and the holder neck.

The fixing unit may further include a holder packing located between the stator can and the support flange.

The motor assembly may further include a stator located between the stator can and the motor housing, and the stator may include a core formed by stacking a plurality of stator core thin plates, and a winding wound on the core, and including a through part passing through the core and a bunch part facing the core.

Thin plate grooves may be formed in the plurality of stator core thin plates, respectively, and the thin plate grooves are located to be aligned with each other in one direction.

The motor assembly may further include an insulator located between the bunch part and the motor housing to prevent the bunch part from contacting the motor housing, and surrounding at least a portion of the bunch part.

The insulator may include an insulator body contacting the core to prevent vibration of the core.

Thin plate grooves may be formed in the plurality of stator core thin plates, respectively, and the thin plate grooves are located to be aligned with each other in one direction, and the insulator may further include fixing ribs extending from the insulator body to be accommodated in the thin plate grooves.

An outer surface of the fixing rib may have a curved surface located on an imaginary curved surface, on which an outer surface of the core is formed.

The insulator may have an concave interference preventing groove at a portion, at which the fixing rib starts to extend, in an opposite direction to a direction, in which the fixing rib extends.

The insulator may be fixed to the motor housing.

The core may contact the motor housing.

According to another aspect of the present disclosure, a pump includes a motor assembly, and an impeller that is rotated by the motor assembly, and the motor assembly includes a rotary shaft coupled to the impeller, a bearing coupled to be adjacent to one end of the rotary shaft, a stator can, at least a portion of the rotary shaft is accommodated, and in which the bearing is accommodated, a bushing holder coupled to the bearing, and including a holder neck extending along an extension direction of the rotary shaft such that at least a portion thereof protrudes to an outside of the stator can, a plug bolt coupled to an end of the bushing holder along the extension direction of the rotary shaft, and a motor housing accommodating the stator can, and including a support flange located between the plug bolt and the bushing holder, and that contacts the holder neck to prevent distortion of the rotary shaft.

The pump may further include a stator located between the stator can and the motor housing, and the stator may include a core formed by stacking a plurality of stator core thin plates, and a winding wound on the core, and including a through part passing through the core and a bunch part facing the core.

Thin plate grooves may be formed in the plurality of stator core thin plates, respectively, and the thin plate grooves are located to be aligned with each other in one direction.

The pump may include an insulator located between the bunch part and the motor housing to prevent the bunch part from contacting the motor housing, and surrounding at least a portion of the bunch part, and the insulator may include an insulator body contacting the core to prevent vibration of the core, and fixing ribs extending from the insulator body to be accommodated in the thin plate grooves.

According to another aspect of the present disclosure, a boiler includes a pump, and a heat exchanger that receives water from the pump, the pump includes a motor assembly, and an impeller that is rotated by the motor assembly, and the motor assembly includes a rotary shaft coupled to the impeller, a fixing unit that fixes the rotary shaft, and including a bearing coupled to be adjacent to one end of the rotary shaft, and a motor housing accommodating at least a portion of the fixing unit, and directly contacting the fixing unit to support the fixing unit.

### BRIEF DESCRIPTION OF THE DRAWINGS

The above and other objects, features and advantages of the present disclosure will be more apparent from the following detailed description taken in conjunction with the accompanying drawings:

FIG. 1 is a conceptual view of a boiler according to a first embodiment of the present disclosure;

FIG. 2 is a perspective view of a pump illustrated in FIG. 1;

FIG. 3 is a cross-sectional view of the pump illustrated in FIG. 2, taken along line III-III′;

FIG. 4 is an enlarged cross-sectional view illustrating IV corresponding to a motor assembly in the pump illustrated in

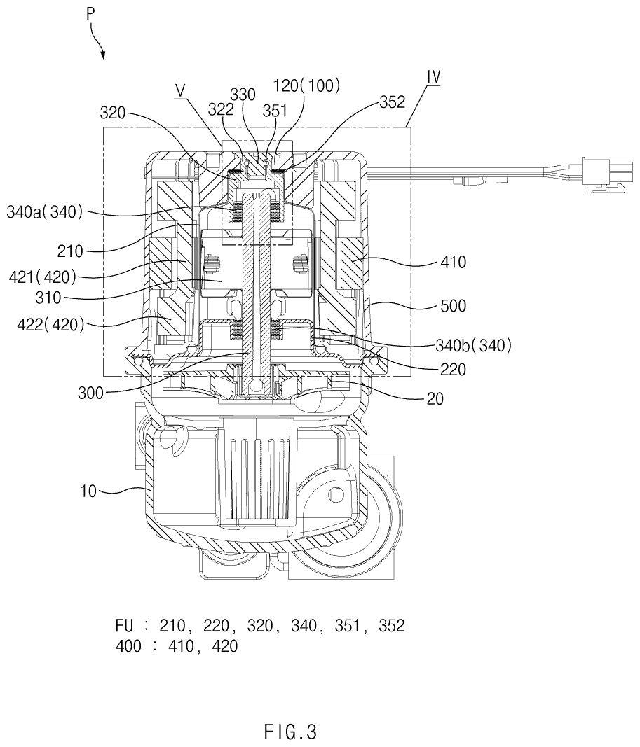

FIG. 3;

FIG. 5 is an enlarged cross-sectional view illustrating V in the pump illustrated in FIG. 3;

FIG. 6 is an exploded perspective view illustrating a configuration related to a fixing unit illustrated in FIG. 5;

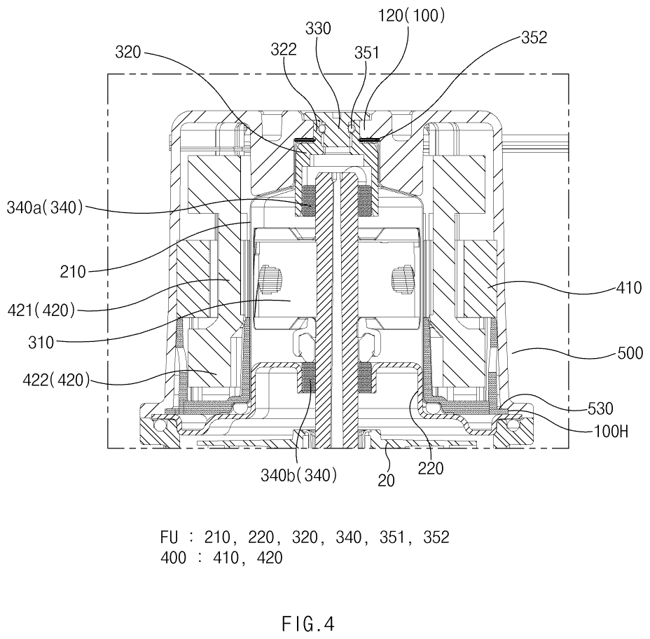

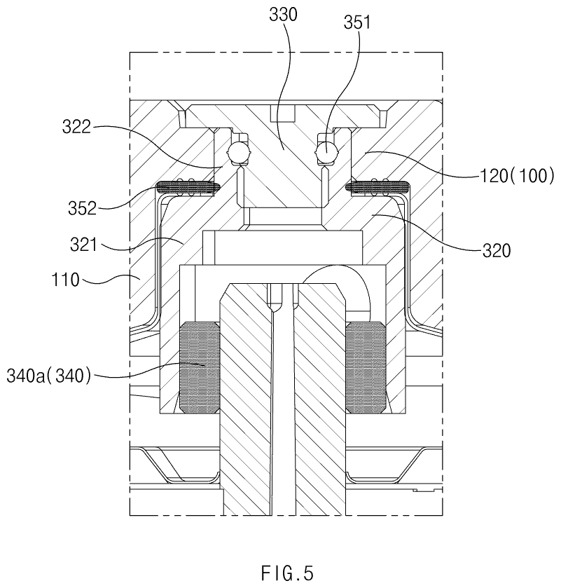

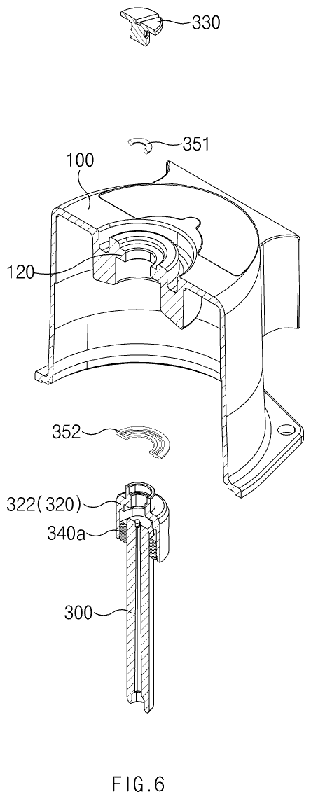

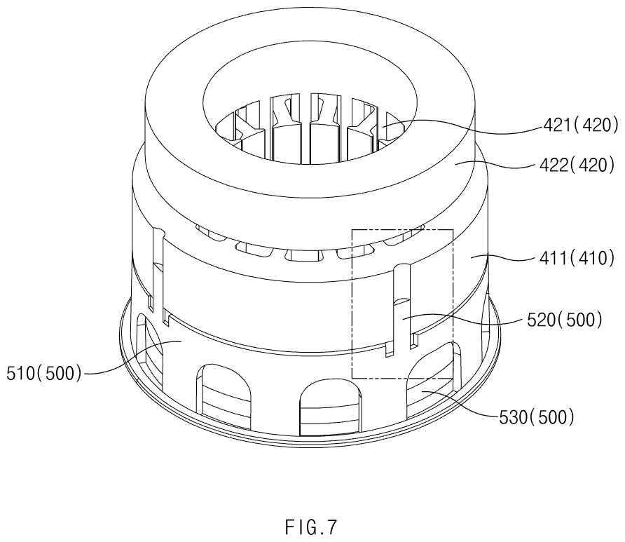

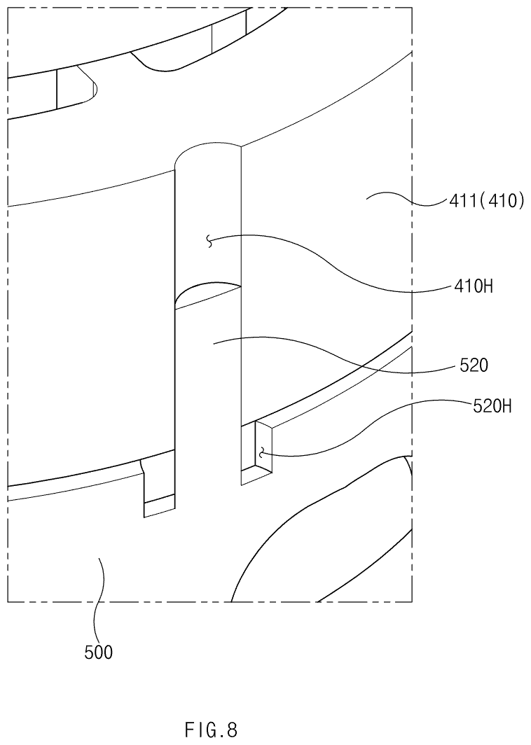

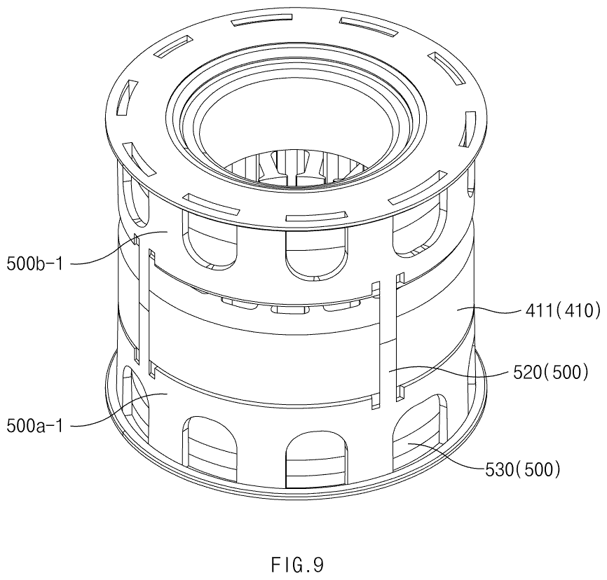

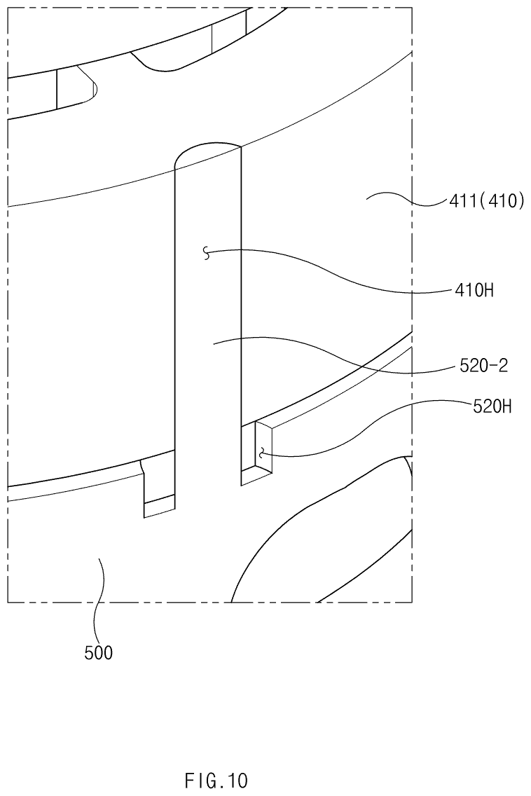

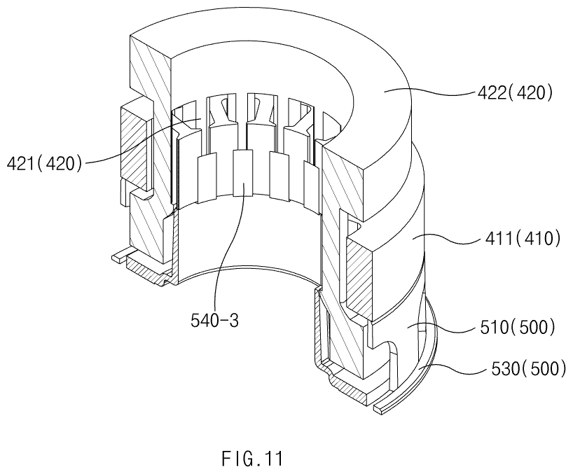

FIG. 7 is a perspective view illustrating a configuration related to a stator illustrated in FIG. 4;

FIG. 8 is an enlarged perspective view of a part of a fixing rib illustrated in FIG. 7;

FIG. 9 is a perspective view illustrating a configuration related to a stator according to a second embodiment of the present disclosure;

FIG. 10 is an enlarged perspective view of a part of a fixing rib according to a third embodiment of the present disclosure; and

FIG. 11 is a cross-sectional perspective view illustrating a configuration related to a stator according to a fourth embodiment of the present disclosure.

### DETAILED DESCRIPTION

Hereinafter, embodiments of the present disclosure will be described in detail with reference to the accompanying drawings so that those skilled in the art may easily carry out the present disclosure. However, the present disclosure may be implemented in several different forms, and is neither limited nor limited by the following embodiments.

To clearly explain the present disclosure, a detailed description of parts that are not related to the description or related known technologies that may unnecessarily obscure the gist of the present disclosure will be omitted, and when adding reference numerals to components of each drawing in the specification, the same or similar reference numerals are attached throughout the specification

In addition, terms or words used in the specification and claims should not be interpreted as being limited to ordinary or dictionary meanings, and should be interpreted as meanings and concepts that are consistent with the technical idea of this present disclosure based on the principle that the inventor may properly define the concepts of the terms to explain his or her invention in the best way.

Various embodiments of the present disclosure and terms used herein are not intended to limit the technical features described in the present disclosure to specific embodiments, and it should be understood that the embodiments and the terms include modification, equivalent, or alternative on the corresponding embodiments described herein.

With regard to description of drawings, similar or related components may be marked by similar reference marks/numerals.

The singular form of the noun corresponding to an item may include one or more of items, unless interpreted otherwise in context.

In the disclosure, the expressions “A or B”, “at least one of A and B”, “at least one of A or B”, “A, B, or C”, “at least one of A, B, and C”, and “at least one of A, B, or C” may include any and all combinations of one or more of the associated listed items.

The term “and/or” includes a combination of a plurality of related described components or any one of a plurality of related described components.

The terms, such as “first” or “second” may be used to simply distinguish the corresponding component from the other component, but do not limit the corresponding components in other aspects (e.g., importance or order).

When a component (e.g., a first component) is referred to as being “coupled with/to” or “connected to” another component (e.g., a second component) with or without the term of “operatively” or “communicatively”, it may mean that a component is connectable to the other component, directly (e.g., by wire), wirelessly, or through the third component.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

When a component is “connected,” “combined,” “support” or “in contact” with another component, this includes not only when the components are directly connected, combined, supported, or in contact, but also the components are indirectly connected, combined, supported, or in contact, through a third component.

When a component is located “on” another component, this includes not only when one component is in contact with another component, but also when another component exists between the two components.

On the other hand, the terms an “upward/downward direction”, a “lower side”, and a “forward/rearward direction” used in the following description are defined based on the drawing, and the shape and position of each component are not limited by the terms.

Hereinafter, embodiments of the present disclosure will be described in detail with reference to the accompanying drawings.

### First Embodiment

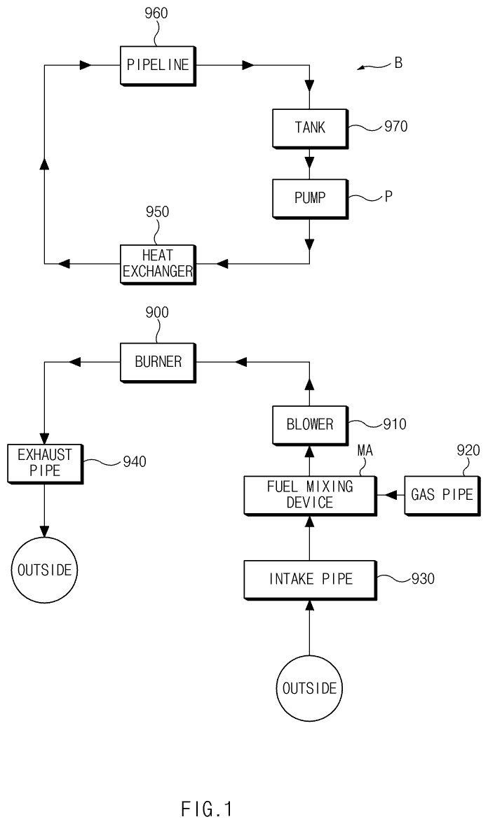

FIG. 1 is a conceptual view of a boiler according to a first embodiment of the present disclosure.

A boiler according to a first embodiment of the present disclosure will be schematically described with reference to FIG. 1.

Prior to a description, a pump “P” of the present disclosure will be described below as being provided to the boiler. However, the present disclosure is not limited thereto, and it is apparent that the spirit of the present disclosure is also applied to the pump “P” provided to an apparatus that uses the pump “P” to apply a pressure to a fluid, such as water. Furthermore, a motor assembly MA of the present disclosure will be described below as being provided to the pump “P”. However, the present disclosure is not limited thereto, and it is considered that the power of a motor may be used wherever the power of the motor is required. However, for convenience of description, it is assumed that the pump “P” is provided to the boiler and the motor assembly MA is provided to the pump “P”.

Boilers may be provided to provide heating or hot water.

In the boiler, a portion, through which water flows, and a portion, through which air and/or fuel flows, may be distinguished. In this case, the idea of the present disclosure may also be applied to that a portion, through which water flows, is substituted with a fluid for transferring heat. However, for convenience of description, water is assumed as an example. Furthermore, the fuel may be provided in a liquid state, but in the present disclosure, for convenience of description, it is assumed in the description that the fuel is provided in a gaseous state.

With reference to the illustration of FIG. 1, a circuit that is located on an upper side may be a portion, through which water flows, and a circuit that is located on a lower side may be a portion, through which air and/or fuel flows. The portion, through which water flows, may be provided as a closed circuit. However, in some cases, a portion, through which water is supplied to the closed circuit, and a portion, through which water is discharged, may be included. For convenience of description, as an example, it is assumed that a portion, through which water flows, is provided as a closed circuit. A portion, through which air flows, may be provided as an open circuit. This is because, once air is burned in a burner 900, combustion products remain and the combustion products need to be discharged to an outside.

A portion, through which the water flows, will be described first. The portion, through which the water flows, may include a heat exchanger 950, a pipeline 960 that is configured to allow water from the heat exchanger 950 to flow to discharge heat at a desired site, and a pump “P” that provides power to allow the water from the pipeline 960 to be introduced back into the heat exchanger 950. The portion, through which the water flows, may additionally include a tank 970 for relieving a pressure that is increased in the pipeline 960 when the water evaporates due to a high temperature while the water flows. Heat may be applied to water in the heat exchanger 950 by the burner 900. The water in the heat exchanger 950 may flow toward the pipeline 960 at a site, at which heat is required, while a temperature thereof is increased. In this case, the flow of the water may be performed by the power provided by the pump “P” described above. The water that discharges heat at a site, at which the pipeline 960 is required, may flow toward the pump “P”. When water evaporates to become water vapor in a gaseous state, the water vapor may be discharged to the outside through the tank 970. The water that passes through the tank 970 may flow toward the pump “P”. In the pump “P”, the water may obtain power and flow back to the heat exchanger 950. The water may circulate along a circulation circuit.

A portion, at which the air and/or fuel flows, will be described. A portion, at which air is introduced, and a portion, at which fuel is introduced, may be distinguished from each other. The air may be introduced into the fuel mixing apparatus MA from the outside through an intake pipe 930. Gas may be introduced into the fuel mixing apparatus MA through a gas pipe 920. In this case, although not illustrated in FIG. 1, a gas valve (not illustrated) may be installed in the gas pipe 920 to adjust an amount of the fuel introduced into the fuel mixing apparatus MA. The air and the fuel may be mixed in the fuel mixing apparatus MA and be provided to a burner 900 through a blower part 910. Although it is illustrated in FIG. 1 that the blower part 910 is located between the fuel mixing apparatus MA and the burner 900, the blower part 910 may be located on an upstream side of the fuel mixing apparatus MA with respect to the flow of the air. A mixture of the air and the fuel is burned in the burner 900, and the air and the like after combustion may be discharged to the outside through an exhaust pipe 940.

The pump “P” will be described in more detail below.

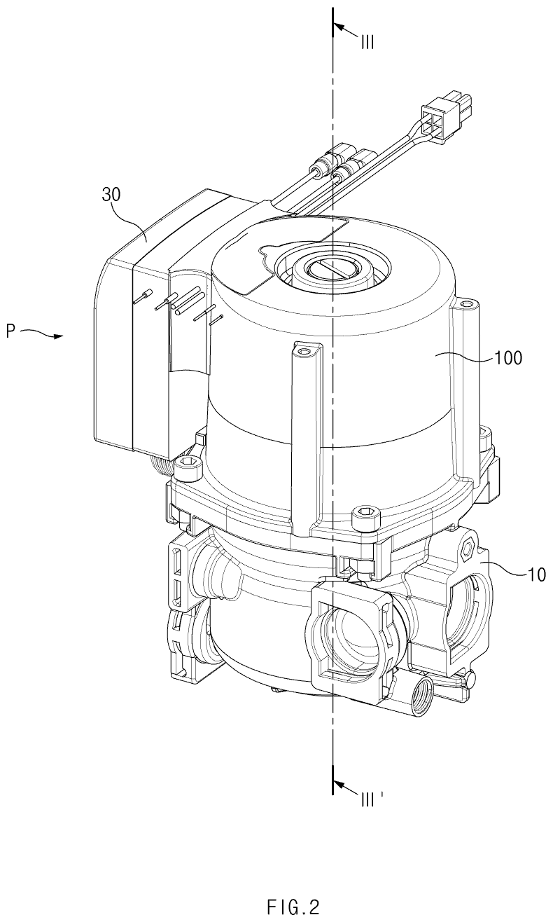

FIG. 2 is a perspective view of a pump “P” illustrated in FIG. 1. FIG. 3 is a cross-sectional view of the pump “P” illustrated in FIG. 2, taken along line III-III′. FIG. 4 is an enlarged cross-sectional view illustrating IV corresponding to a motor assembly MA in the pump “P” illustrated in FIG. 3. FIG. 5 is an enlarged cross-sectional view illustrating V in the pump “P” illustrated in FIG. 3. FIG. 6 is an exploded perspective view illustrating a configuration related to a fixing unit FU illustrated in FIG. 5.

Referring to FIGS. 2 to 6, the pump “P” and the motor assembly MA according to the first embodiment of the present disclosure will be described.

As described above, the pump “P” configured to generate power for a fluid, such as water, to flow may be provided. The fluid, such as water, will be referred to and described as water for convenience in the present disclosure.

As illustrated in FIG. 3, the pump “P” may include an impeller 20. The pump “P” may include a pump housing 10 that accommodates the impeller 20. The water that passes through the pipeline 960 may be introduced into the pump housing 10. The water that is introduced into the pump housing 10 flows as the impeller 20 is rotated, and as illustrated in FIG. 2, the flowing water may flow toward the heat exchanger 950 through a hole that is formed in the pump housing 10. In this case, the impeller 20 may may receive power from the motor assembly MA to be rotated. For reference, as illustrated in FIG. 2, the movement of the motor assembly MA may be controlled by receiving a control signal from a controller 30. The controller 30 may include a processor (not illustrated), a memory (not illustrated), and the like.

As illustrated in FIG. 3, the motor assembly MA may include a rotary shaft 300 that is coupled to the impeller 20 to rotate the impeller 20. As illustrated in FIG. 4, the motor assembly MA may include a rotor 310 and a stator 400. Because the rotor 310 and the stator 400 included in the motor assembly MA are generally understood by those skilled in the art, a description thereof will be omitted in the present disclosure. The rotary shaft 300 may be coupled to the rotor 310, and may be rotated as the rotor 310 is rotated.

The motor assembly MA may include a fixing unit FU that is configured to fix the rotary shaft 300. The rotary shaft 300 may be inserted into the fixing unit FU so that a movement other than the rotation direction may be restricted. As illustrated in FIG. 4, the rotary shaft 300 may extend in the upward/downward direction, and the fixing unit FU may restrict forward, rearward, leftward, and rightward movements of the rotary shaft 300 by supporting the front, rear, and left sides of the rotary shaft 300. The upward/downward movement of the rotary shaft 300 may be restricted by coupling the rotary shaft 300 to the fixing unit FU through interference fitting, and thus, the rotary shaft 300 may be fixed to the fixing unit FU by a frictional force. The fixing unit FU may be a rigid body to support the rotary shaft 300. For example, the fixing unit FU may have a metallic material.

Additionally, the fixing unit FU may be located on an outside of the rotary shaft 300 to protect the rotary shaft 300.

In this case, the fixing unit FU may include a bearing 340 that is coupled to be adjacent to one end of the rotary shaft 300. As illustrated in FIG. 5, the bearing 340 may be located in a position that is spaced inward apart from an end of the rotary shaft 300, or may be located at an end of the rotary shaft 300, unlike the illustration of FIG. 5. Accordingly, the rotary shaft 300 may be supported by the bearing 340.

Although a single bearing 340 may be provided, and may support the rotary shaft 300, as illustrated in FIG. 4, a plurality of bearings 300 may be provided at opposite ends of the rotary shaft 300. The plurality of bearings 340 may include an upper bearing 340a that is located on an upper side, and/or a lower bearing 340b that is located on a lower side with reference to FIG. 4. When the description of the bearing 340 in the present disclosure is understood with reference to the drawing, there may be one that is understood with reference to the upper bearing 340a. However, because the description may be applied to both the upper bearing 340a and the lower bearing 340b, it is not interpreted that the description is limited to the drawing and is applied only to the upper bearing 340a, and it may be considered that the idea applied in the present disclosure is applied to at least one of the upper bearing 340a and the lower bearing 340b. However, for convenience of understanding, the bearing 340 hereinafter may be understood as an upper bearing 340a. When the rotary shaft 300 is supported by only one bearing 340, a torque is generated around a point that is supported by the bearing 340 so that the rotational axis of the rotary shaft 300 may be inclined. However, as illustrated in FIG. 4, the upper bearing 340a and the lower bearing 340b are located at the upper and lower sides of the rotary shaft 300, respectively, and each bearing 340 supports the rotary shaft 300, so that the rotation axis of the rotary shaft 300 may be prevented from being inclined. For reference, the lower bearing 340b is included in the fixing unit FU, and may be supported by an end plate 220 that closes a lower opening of a stator can 210.

The motor assembly MA may include a motor housing 100 that forms an exterior appearance thereof. The motor housing 100 may accommodate at least a portion of the fixing unit FU. Moreover, the motor housing 100 may accommodate the rotor 310 and/or the stator 400. The motor assembly MA may be formed of a rigid body to protect the components accommodated therein. For example, the motor assembly MA may include a metallic material.

In this case, when examining the relationship between the motor housing 100 and the fixing unit FU, it may be considered that a separate component is provided between the fixing unit FU and the motor housing 100. For example, a structure, in which the fixing unit FU is surrounded by a packing formed of rubber or the like, and the packing and the motor housing 100 contact each other, may be considered. In this case, even when the shape of the fixing unit FU and the shape of the motor housing 100 do not accurately correspond to each other, a tolerance may be supplemented by the packing. Due to the packing, the motor housing 100 and the fixing unit FU are firmly coupled at the beginning, but vibration may occur in the fixing unit FU as the rotary shaft 300 is rotated, and thus, a portion of the packing may be worn out. Accordingly, toward the end of use, the packing may not completely supplement a gap between the fixing unit FU and the motor housing 100, and the vibration of the fixing unit FU may become more severe. When the vibration of the fixing unit FU becomes severe, noise may be generated stronger. The present disclosure may solve this problem.

The motor housing 100 may directly contact the fixing unit FU to support the fixing unit FU. The technology using the packing is intended to compensate for the problem that the shape between the fixing unit FU and the motor housing 100 does not accurately match. However, when the motor housing 100 and the fixing unit FU have shapes that accurately correspond to each other, a noise problem due to vibration may not occur even when the motor housing 100 and the fixing unit FU contact each other without packing, In particular, when elaborate production is possible and thus it is easy to produce the motor housing 100 and the fixing unit FU to have a desired shape, the technology of this method may be more effective. Hereinafter, it will be described in more detail.

Although the fixing unit FU may be formed of a single body, the fixing unit FU may be formed of several bodies in consideration of the fact that it is not easy to form a single body in production technology and that shapes and materials for special functions may be used in each body when formed of the respective bodies. The fixing unit FU may include a stator can 210, in which at least a portion of the rotary shaft 300 is accommodated. The stator can 210 may have a thickness that is smaller than that of the motor housing 100. The stator can 210 may accommodate the rotor 310 and be located between the rotor 310 and the stator 400 to form a boundary between the rotor 310 and the stator 400. The motor housing 100 may contact the stator can 210. Accordingly, vibration of the stator can 210 may be suppressed. Particularly, as illustrated in FIG. 3, a portion of the stator can 210, which is spaced apart from the impeller 20, may correspond to an inner shape of the motor housing 100 to contact the motor housing 100. As illustrated in FIG. 5, an upper side of the stator can 210 may be opened.

The fixing unit FU may include a bushing holder 320, in which the bearing 340 is accommodated, and at least a portion of which is accommodated in the stator can 210. The bearing 340 may be fitted with the bushing holder 320. The bushing holder 320 may be fitted with the stator can 210. That is, one end of the rotary shaft 300 may be supported by the bearing 340, the bearing 340 may be supported by the bushing holder 320, and the bushing holder 320 may be supported by the stator can 210.

More specifically, the bushing holder 320 may include a bushing holder body 321, to which the bearing 340 is coupled. In particular, here, the bearing 340 may be an upper bearing 340a. For example, the bushing holder 320 that supports the lower bearing 340b may be provided, but for convenience of description, in the present disclosure, it is assumed that the upper bearing 340a may be coupled to the bushing holder body 321, as illustrated in FIG. 5. The bushing holder 320 may include a holder neck 322 that extends from the bushing holder body 321 to the outside of the stator can 210 along an extension direction of the rotary shaft 300. For example, the holder neck 322 may extend upward with reference to FIG. 5. The holder neck 322 may extend through an opening that is formed on an upper side of the stator can 210. A cross-sectional area of the holder neck 322 may be smaller than that of the bushing holder body 321. Because the bushing holder body 321 needs to accommodate the upper bearing 340a, it needs to have a width that is sufficient to accommodate the width of the bearing 340, but the bushing holder neck 322 may have a smaller width than the bushing holder body 321 because it does not need to accommodate the upper bearing 340a.

Moreover, as illustrated in FIG. 5, the stator can 210 may include a part that extends toward the holder neck 322 to cover an upper portion of the bushing holder body 321, which is located adjacent to a portion, at which the holder neck 322 starts to extend. Additionally, for the stator can 210 to be located adjacent to the rotor 310, as illustrated in FIG. 4, an intermediate point, at which the rotor 310 is located, has a width corresponding to the rotor 310, and an upper point, at which the bushing holder 320 is located to support the bushing holder 320 located on an upper side of the rotor 310 may have a width that is smaller than the rotor 310 and corresponding to the bushing holder 320.

In this case, the holder neck 322 may not be supported by the stator can 210. The holder neck 322 may be directly supported by the motor housing 100.

In other words, the motor housing 100 may include a support flange 120 that contacts the holder neck 322. The support flange 120 may extend toward the holder neck 322. A corresponding portion of the motor housing 100 may be formed to have a width corresponding to that of the stator can 210 located on an outside of the bushing holder body 321 while having a width corresponding to that of the bushing holder body 321. Because the support flange 120 of the motor housing 100, which is located on an upper side of the portion, has contact the holder neck 322 having a width that is smaller than that of the bushing holder body 321, it may extend further toward the holder neck 322 than the portion located on the lower side.

The fixing unit FU may include a plug bolt 330 that is coupled to the holder neck 322 along the extension direction of the rotary shaft 300. The plug bolt 330 may include a bolt head and/or a bolt neck. The holder neck 322 may be provided to be coupled to the bolt neck. The bolt neck may be accommodated in the holder neck 322 and the bolt head may be provided to cover an end of the holder neck 322. The bolt head may extend further than the bolt neck in a radial direction. The bolt head may be exposed to the outside of the motor housing 100. More specifically, with reference to FIG. 4, after the bushing holder 320 is accommodated in the upper opening of the motor housing 100, the plug bolt 330 may be moved downward from the upper side of the bushing holder 320 located on an outside of the motor housing 100 to accommodate the bolt neck in the holder neck 322. Thereafter, the bolt head may be supported by the motor housing 100 to prevent movement to a lower side of the bushing holder 320. For reference, the motor housing 100 may include a holder accommodating part 110 that is configured to receive the bushing holder 320.

In this case, the support flange 120 may be located between the bushing holder body 321 and the plug bolt 330. The support flange 120 may contact the plug bolt 330. Vibration of the rotary shaft 300 may be transmitted to the plug bolt 330 through the bearing 340 and the bushing holder 320, and because the plug bolt 330 may be supported by the rigid motor housing 100, vibration of the rotary shaft 300 may be further reduced. Furthermore, because the support flange 120 contacts all of the holder neck 322, the stator can 210, and the plug bolt 330 of the bushing holder 320, it may contact most of the components that constitute the fixing unit FU, vibration of the rotary shaft 300 may be effectively reduced. For example, the support flange 120 located on the right side of FIG. 4 may contact the holder neck 322 of the bushing holder 320 on the left side, contact the bolt head of the plug bolt 330 on the upper side, and contact the stator can 210 on the lower side.

The rotor 310 may be included inside the stator can 210, and it is necessary to prevent foreign substances or moisture from penetrating into the rotor 310. To this end, a packing may be provided between the separated components. More specifically, as illustrated in FIGS. 5 to 6, the fixing unit FU may further include a bolt packing 351 that is located between the plug bolt 330 and the holder neck 322. The plug bolt 330 may have a groove for accommodating the bolt packing 351. The bolt packing 351 may have an annular shape. The groove formed in the plug bolt 330 may be formed in the bolt neck to correspond to the shape of the bolt packing 351. The bolt packing 351 may seal a gap that is formed between the plug bolt 330 and the bushing holder 320.

The fixing unit FU may include a holder packing 352 that is located between the stator can 210 and the support flange 120. As illustrated in FIGS. 5 to 6, the holder packing 352 may extend radially inward to contact the holder neck 322. Moreover, the holder packing 352 may extend radially outward to contact a point, at which the support flange 120 starts to extend. The holder packing 352 may seal an aperture that is formed between the holder neck 322 of the bushing holder 320 and the support flange 120, and may seal an aperture that is formed between the stator can 210 and the support flange 120.

Moreover, because the bolt packing 351 and the holder packing 352 may offset the vibration between the components in contact, the vibration of the rotary shaft 300 may be offset.

In the above, the fixing unit FU that offsets the vibration of the rotary shaft 300 to fix the rotary shaft 300 has been described. Hereinafter, an embodiment of the present disclosure, in which the vibration in the stator 400 may be offset when the vibration is transmitted to the stator 400 to offset the vibration by the rotary shaft 300, will be described.

FIG. 7 is a perspective view illustrating a configuration related to a stator 400 illustrated in FIG. 4. FIG. 8 is an enlarged perspective view of a part of a fixing rib 520 illustrated in FIG. 7.

Referring to FIGS. 7 to 8, the stator 400 according to a first embodiment of the present disclosure and a configuration related thereto will be described.

As illustrated in FIG. 5, the stator 400 may be located between the stator can 210 and the motor housing 100. As illustrated in FIG. 7, the stator 400 may include a core 410, in which a plurality of stator core thin plates 411 are stacked. An outer surface of the core 410 may have a side shape of a cylinder. The stator 400 may include a winding 420 that is wound around the core 410. Current may flow through the winding 420. The winding 420 may include a through part 421 that passes through the core 410. The winding 420 may include a bunch part 422 that faces the core 410. Referring to FIG. 7, the through part 421 may extend in the upward/downward direction, and the bunch part 422 may be located at an end of the through part 421 to have an annular shape. The bunch part 422 may extend less than the outer surface of the core 410 in the radial direction.

The motor assembly MA may include an insulator 500 that is located between the bunch part 422 and the motor housing 100 to prevent the bunch part 422 from contacting the motor housing 100. The bunch part 422 is a component of the winding 420, and thus current may flow therethrough. Because the motor housing 100 may be formed of a metal material as described above, it is necessary to prevent the bunch part 422 from contacting it. The insulator 500 may surround at least a portion of the bunch part 422.

The insulator 500 may include an insulator body 510 that contacts the core 410 to prevent vibration of the core 410. When the insulator body 510 and the core 410 contact each other, vibration of the core 410 may be dispersed to the insulator body 510.

Thin plate grooves 410H may be formed in a plurality of stator core thin plates 411, respectively. The positions of the plurality of stator core thin plates 411 may be aligned by aligning the thin plate grooves 410H formed in the stator core thin plate 411 in one direction. A hole, through which the through part 421 of the winding 420 passes, is formed in the stator core thin plate 411, and the through part 421 of the winding 420 may pass through the holes formed in the stator core thin plate 411 when the holes have to be aligned.

In this case, the insulator 500 may include a fixing rib 520 that extends from the insulator body 510 to be accommodated in the thin plate groove 410H. As illustrated in FIG. 8, the fixing rib 520 may extend toward the bunch part 422 while being accommodated in the thin plate groove 410H. The vibration of the rotary shaft 300, which is transmitted to the core 410, may be transmitted to the fixing rib 520 and be distributed to the insulator 500. Moreover, because the movement of the core 410 is limited by the fixing rib 520, generation of the vibration of the core 410 may be prevented.

An outer surface of the fixing rib 520 may have a curved surface that is located on an imaginary curved surface formed by the outer surface of the core 410. Accordingly, a curved surface connected between the outer surface of the fixing rib 520 and the outer surface of the core 410 may be formed. The connected curved surface may allow the core 410 and the fixing rib 520 to contact the motor housing 100 at the same time.

The insulator 500 may have a concave interference preventing groove 520H that is formed in an opposite direction to a direction, in which the fixing rib 520 extends, at a portion, at which the fixing rib 520 starts to extend. The insulator 500 may have a plastic material. Moreover, the insulator 500 may be formed through injection-molding. The interference preventing groove 520H may prevent a protrusion from being formed adjacent to the fixing rib 520 due to formation of the fixing rib 520 when the insulator 500 is formed through injection-molding, or may prevent the protrusion from contacting the core 410 even when the protrusion is formed. That is, the interference preventing groove 520H may be deeper than the height of the protrusion that may be formed.

The insulator 500 may be fixed to the motor housing 100. Because the insulator 500 is fixed to the motor housing 100, generation of vibration that is generated when the insulator 500 and the motor housing 100 contact each other may be prevented. The insulator 500 may include a fixing flange 530 that protrudes toward the motor housing 100. The motor housing 100 may be provided such that an insulator fixing groove 100H (see FIG. 4) that accommodates the fixing flange 530 is formed and the fixing flange 530 is interference-fitted with the fixing groove.

As described above, the core 410 may contact the motor housing 100. In particular, the inner surface of the core 410 contacts the stator can 210 (see FIG. 4), and the outer surface of the core 410 contacts the motor housing 100, and the core 410 may distribute vibrations to respective components.

Hereinafter, an embodiment that is different from the first embodiment will be described. Contents that are common to those of the first embodiment will be omitted as much as possible, and other embodiments will be described focusing on differences. That is, it is apparent that contents that are not described in other embodiments may be supplemented through the contents of the first embodiment when necessary.

### Second Embodiment

FIG. 9 is a perspective view illustrating a configuration related to a stator 400 according to a second embodiment of the present disclosure.

Referring to FIG. 9, an insulator 500 according to a second embodiment of the present disclosure will be described.

The second embodiment is different from the first embodiment in that a pair of insulators 500 are provided.

The insulator 500 may include a first insulator 500a-1 that accommodates one bunch part 422 and a second insulator 500b-1 that accommodates the other bunch part 422. The fixing rib 520 included in the first insulator 500a-1 is accommodated in the same thin plate groove 410H of the fixing rib 520 included in the second insulator 500b-1 to better fix the core 410.

### Third Embodiment

FIG. 10 is an enlarged perspective view of a part of a fixing rib 520 according to a third embodiment of the present disclosure.

Referring to FIG. 10, a fixing rib 520 according to a third embodiment of the present disclosure will be described.

The third embodiment is different from the first embodiment in that the fixing rib 520-2 has a different length.

The fixing rib 520-2 may extend to correspond to the length of the thin plate groove 410H. Accordingly, the entire stator core thin plate 411 may be supported by the fixing rib 520-2.

### Fourth Embodiment

FIG. 11 is a cross-sectional perspective view illustrating a configuration related to a stator 400 according to a fourth embodiment of the present disclosure.

Referring to FIG. 11, an inner fixing part 540-3 according to a fourth embodiment of the present disclosure will be described.

The fourth embodiment is different from the first embodiment in that the insulator 500 further includes an inner fixing part 540-3.

The inner fixing part 540-3 may support an inside of the core 410. The inner fixing part 540-3 may extend from the insulator body 510. Because the inner fixing part 540-3 fixes the core 410, the generation of vibration in the core 410 may be further suppressed.

The motor assembly according to the present disclosure may prevent the rotation axis of the rotary shaft from being inclined by causing the fixing unit that fixes the rotary shaft to directly contact the motor housing.

The pump and the boiler according to the present disclosure may suppress vibration and noise generation by providing the motor assembly.

Effects obtained in the present disclosure are not limited to the above-mentioned effects, and other effects that are not mentioned will be clearly understood by those skilled in the art, to which the present disclosure belongs, from the following description.

Unless explicitly stated, the embodiments described above may be combined with other embodiments. Alternatively, it may be considered that combinations of the embodiments are possible, unless one embodiment is explicitly limited in combination with another embodiment. It is considered that any combination of any of the embodiments herein is disclosed in this document.

Although the present disclosure has been described above by means of limited embodiments and drawings, the present disclosure is not limited thereto, and various embodiments are possible within the scope that is equivalent to the technical idea of the present disclosure and the scope of the patent claims to be described below by a person skilled in the art, to which the present disclosure pertains.

What is claimed is:

1. A motor assembly comprising:
a rotary shaft;
a fixing unit configured to support the rotary shaft such that the rotary shaft is rotatable; and
a motor housing accommodating at least a portion of the fixing unit, and directly contacting the fixing unit to support the fixing unit.

2. The motor assembly of claim 1, wherein the fixing unit includes:
a bearing coupled to be adjacent to one end of the rotary shaft;
a stator can, in which at least a portion of the rotary shaft is accommodated; and
a bushing holder, in which the bearing is accommodated, and at least a portion of which is accommodated in the stator can, and
wherein the motor housing contacts the stator can.

3. The motor assembly of claim 2, wherein the bushing holder includes:
a bushing holder body, to which the bearing is coupled; and
a holder neck extending along an extension direction of the rotary shaft from the bushing holder body to an outside of the stator can, and
wherein the motor housing includes a support flange contacting the holder neck.

4. The motor assembly of claim 3, wherein the fixing unit further includes a plug bolt coupled to the holder neck along the extension direction of the rotary shaft, and
wherein the support flange is located between the bushing holder body and the plug bolt.

5. The motor assembly of claim 4, wherein the fixing unit further includes a bolt packing located between the plug bolt and the holder neck.

6. The motor assembly of claim 3, wherein the fixing unit further includes a holder packing located between the stator can and the support flange.

7. The motor assembly of claim 2, further comprising:
a stator located between the stator can and the motor housing,
wherein the stator includes:
a core formed by stacking a plurality of stator core thin plates; and
a winding wound on the core, and including a through part passing through the core and a bunch part facing the core.

8. The motor assembly of claim 7, wherein thin plate grooves are formed in the plurality of stator core thin plates, respectively, and the thin plate grooves are located to be aligned with each other in one direction.

9. The motor assembly of claim 7, further comprising:
an insulator located between the bunch part and the motor housing to prevent the bunch part from contacting the motor housing, and surrounding at least a portion of the bunch part.

10. The motor assembly of claim 9, wherein the insulator includes an insulator body contacting the core to prevent vibration of the core.

11. The motor assembly of claim 10, wherein thin plate grooves are formed in the plurality of stator core thin plates, respectively, and the thin plate grooves are located to be aligned with each other in one direction, and
wherein the insulator further includes fixing ribs extending from the insulator body to be accommodated in the thin plate grooves.

12. The motor assembly of claim 11, wherein an outer surface of the fixing rib has a curved surface located on an imaginary curved surface, on which an outer surface of the core is formed.

13. The motor assembly of claim 11, wherein the insulator has a concave interference preventing groove at a portion, at which the fixing rib starts to extend, in an opposite direction to a direction, in which the fixing rib extends.

14. The motor assembly of claim 9, wherein the insulator is fixed to the motor housing.

15. The motor assembly of claim 9, wherein the core contacts the motor housing.

16. A pump comprising:
a motor assembly; and
an impeller configured to be rotated by the motor assembly,
wherein the motor assembly includes:
a rotary shaft coupled to the impeller;
a bearing coupled to be adjacent to one end of the rotary shaft;
a stator can, at least a portion of the rotary shaft is accommodated, and in which the bearing is accommodated;
a bushing holder coupled to the bearing, and including a holder neck extending along an extension direction of the rotary shaft such that at least a portion thereof protrudes to an outside of the stator can;
a plug bolt coupled to an end of the bushing holder along the extension direction of the rotary shaft; and
a motor housing accommodating the stator can, and including a support flange located between the plug bolt and the bushing holder, and configured to contact the holder neck to prevent distortion of the rotary shaft.

17. The pump of claim 16, further comprising:
a stator located between the stator can and the motor housing,
wherein the stator includes:
a core formed by stacking a plurality of stator core thin plates; and
a winding wound on the core, and including a through part passing through the core and a bunch part facing the core.

18. The pump of claim 17, wherein thin plate grooves are formed in the plurality of stator core thin plates, respectively, and the thin plate grooves are located to be aligned with each other in one direction.

19. The pump of claim 18, comprising:
an insulator located between the bunch part and the motor housing to prevent the bunch part from contacting the motor housing, and surrounding at least a portion of the bunch part,
wherein the insulator includes:
an insulator body contacting the core to prevent vibration of the core; and
fixing ribs extending from the insulator body to be accommodated in the thin plate grooves.

20. A boiler comprising:
a pump; and
a heat exchanger configured to receive water from the pump, wherein the pump includes:
a motor assembly; and
an impeller configured to be rotated by the motor assembly, wherein the motor assembly includes:
a rotary shaft coupled to the impeller;
a fixing unit configured to fix the rotary shaft, and including a bearing coupled to be adjacent to one end of the rotary shaft; and
a motor housing accommodating at least a portion of the fixing unit, and directly contacting the fixing unit to support the fixing unit.
